(19) United States
(12) Patent Application Publication
(10) Pub. No.: US 2026/0159090 A1
(43) Pub. Date: Jun. 11, 2026

(54) SYSTEM AND METHOD FOR INCAPACITATED DRIVER DETECTION

(71) Applicant: Torc Robotics, Inc., Blacksburg, VA (US)

(72) Inventors: Maximilian Koeper, Ostfidern (DE); Marat Kopytjuk, Heilbronn (DE); Margarita Kunjavskaja, Gerlingen (DE); Maximilian Yassine Beyen, Leutenbach (DE); Simon Baeuerle, Kassel (DE)

(21) Appl. No.: 18/971,841

(22) Filed: Dec. 6, 2024

(51) Int. Cl. B60W 30/182; G06V 20/58; G06V 20/59

(52) U.S. Cl. CPC B60W 30/182; G06V 20/58; G06V 20/597; B60W 2540/26

(57) ABSTRACT

A system for incapacitated driver detection is provided. The system includes at least one sensor configured to be located on a vehicle. The at least one sensor includes a field-of-view directed outward away from the vehicle. The system includes a processing device in communication with the at least one sensor and configured to execute instructions stored in a memory to perform operations including detecting a secondary vehicle located around or proximate the vehicle. The operations include determining if a driver of the secondary vehicle is incapacitated based on detection of at least one of a driver characteristic associated with the driver, or a vehicle characteristic associated with the secondary vehicle. If the driver of the secondary vehicle is determined to be incapacitated, the operations include adjusting operation of the vehicle into a safety operation mode.

### TECHNICAL FIELD

The field of the disclosure relates to incapacitated driver detection and, in particular, to a system for detecting incapacitated drivers around a vehicle to adjust operation of the vehicle for safer driver and avoiding potential collisions with the incapacitated drivers.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

There are various challenges faced by vehicles and drivers of vehicles on the road. In addition to typical avoidance of surrounding vehicles and objects, the existence of unpredictable drivers and, specifically, distracted or incapacitated drivers, creates additional challenges for vehicle operation. With the advent of smart mobile devices and various other features within vehicles, drivers may become distracted or incapacitated, resulting in swerving of their vehicle within their lane or across lanes. Distracted or incapacitated drivers can also lead to violation of traffic rules, such as passing through a red traffic light, failing to stop at a stop sign, or the like. Such distractions can also lead to unexpected accelerations or decelerations, leading to potential collisions with surrounding vehicles. Systems generally exist within vehicles to warn the driver that they may be distracted or incapacitated, and may recommend taking a break from driving or another action. However, these warnings fail to affect actions of surrounding vehicles to ensure safe passage around incapacitated drivers.

Accordingly, there exists a need for a system and a method of incapacitated driver detection which, upon detection of an incapacitated driver in a surrounding vehicle, adjusts operation of the primary vehicle to avoid a potential collision with the vehicle of the incapacitated driver. These and other needs are met by the exemplary system for incapacitated driver detection discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for incapacitated driver detection is provided. The system includes at least one sensor configured to be located on a vehicle. The at least one sensor includes a field-of-view directed outward away from the vehicle. The system includes a processing device in communication with the at least one sensor. The processing device is configured to execute instructions stored in a memory to perform operations that include detecting a secondary vehicle located around or proximate the vehicle. The operations include determining if a driver of the secondary vehicle is incapacitated based on detection of at least one of (i) a driver characteristic associated with the driver, or (ii) a vehicle characteristic associated with the secondary vehicle. If the driver of the secondary vehicle is determined to be incapacitated, the operations include adjusting operation of the vehicle into a safety operation mode.

In some embodiments, the vehicle can be an autonomous or a semi-autonomous vehicle. In some embodiments, the at least one sensor can be a camera. In some embodiments, the at least one sensor can be radar, LIDAR, or both. In some embodiments, the at least one sensor can be configured to detect the driver within the secondary vehicle and determine the driver characteristic. In some embodiments, the operations can include using machine learning and/or image recognition to determine the driver characteristic. In some embodiments, the driver characteristic can include, e.g., a mobile device distracting the driver, the driver sleeping, eating, or checking a radio within the secondary vehicle, combinations thereof, or the like.

In some embodiments, the at least one sensor can be configured to detect an unexpected trajectory of the secondary vehicle as the vehicle characteristic. In some embodiments, the unexpected trajectory can include, e.g., swerving of the secondary vehicle, higher acceleration of the secondary vehicle relative to surrounding vehicles, uneven acceleration or deceleration of the secondary vehicle, combinations thereof, or the like.

In some embodiments, the safety operation mode can include, e.g., increasing a longitudinal and/or lateral distance of the vehicle relative to the secondary vehicle, guiding the vehicle to a lane further from the secondary vehicle, avoiding a planned lane change which would bring the vehicle closer to the secondary vehicle, accelerating or decelerating the vehicle to increase a distance between the vehicle and the secondary vehicle, combinations thereof, or the like. The operations can include issuing an alert to surrounding vehicles regarding the incapacitated driver and the secondary vehicle.

In another aspect, an exemplary computer-implemented method for incapacitated driver detection is provided. The method includes detecting a secondary vehicle located around a vehicle with at least one sensor configured to be located on the vehicle. The at least one sensor including a field-of-view directed outward away from the vehicle. The method includes executing instructions stored in a memory with a processing device in communication with the at least one sensor to perform operations that include determining if a driver of the secondary vehicle is incapacitated based on detection of at least one of (i) a driver characteristic associated with the driver, or (ii) a vehicle characteristic associated with the secondary vehicle. If the driver of the secondary vehicle is determined to be incapacitated, the operations include adjusting operation of the vehicle into a safety operation mode.

In some embodiments, the operations can include detecting the driver within the secondary vehicle and determining if the driver is distracted by a mobile device. In some embodiments, the operations can include detecting with the at least one sensor an unexpected trajectory of the secondary vehicle as the vehicle characteristic.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for incapacitated driver detection.

FIG. 7 is a flowchart of a method for incapacitated driver detection.

FIG. 8 is a diagrammatic view of an incapacitated driver and a wandering zone associated with a vehicle of the incapacitated driver.

FIG. 9 is a diagrammatic view of a swerving trajectory of a vehicle associated with an incapacitated driver relative to a primary vehicle.

FIG. 10 is an image of a vehicle captured by a sensor of an exemplary system for incapacitated driver detection.

FIG. 11 is an image of a driver of a vehicle distracted by a mobile device as captured by a sensor for an exemplary system for incapacitated driver detection.

FIG. 12 is a diagrammatic view of a primary vehicle and an exemplary incapacitated driver detection system monitoring trajectories of surrounding vehicles.

FIG. 13 is an image of a license plate of a vehicle associated with an incapacitated driver as captured by a sensor of an exemplary system for incapacitated driver detection.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

An incapacitated driver: An incapacitated driver is a driver of a vehicle who is unable to safely operate the vehicle due to a distraction or a physical inability. Such driver is unable to maintain their eyes on the road due to the distraction or the physical inability to do so. For example, the driver may be distracted by actions being taken within the vehicle. Non-limiting examples of these actions can include, e.g., reaching for items in the back seat, eating, checking the radio, checking their phone, make-up application, drinking an alcoholic beverage, arguments within the vehicle with passengers which cause the driver to turn around in the seat, or the like. Additional non-limiting examples of these actions can include, e.g., eating or drinking (consuming food or beverages while driving can divert attention from the road), personal grooming (activities such as applying makeup, shaving, or fixing/brushing hair), interacting with passengers (engaging in deep conversations, looking back to talk to children, or attending to crying babies), adjusting vehicle settings (tinkering with the radio, air conditioning, GPS, or other in-car systems), external distractions (looking at roadside billboards, accidents, or scenic views), reaching for items (stretching to grab something out of reach, such as a dropped item or something in the back seat), pets in the vehicle (unrestrained pets moving around or seeking attention can be a major distraction), reading or writing (reading maps, books, or filling out forms while driving), smoking or vaping (handling cigarettes, lighting them, or managing ashes can take hands off the wheel), or the like. In some instances, the distraction may be outside of the vehicle, such as a car accident that the driver is looking at instead of the road. The driver may have fallen asleep behind the wheel, resulting in the incapacitated state. If the driver has a medical condition, e.g., seizures, or the like, this can also be considered an incapacitated state. If the driver has been drinking alcoholic beverages and is swerving on the road, this can also be considered as an incapacitated state.

The exemplary system includes sensors located on a primary vehicle with a field-of-view directed outward and away from the primary vehicle to monitor surrounding vehicles. In particular, the sensors are configured to detect distracted or incapacitated drivers in the surrounding vehicles as the vehicles move along a road. The sensors can be positioned sufficiently high enough and on all sides of the primary vehicle to allow for visualization and detection of drivers within surrounding vehicles from different angles. Such detection can be performed based on image or video capture of the driver within the secondary vehicle and, through image recognition processing, detecting a distraction, e.g., smart phone, radio, food, or the like. For example, the sensors can capture an image of the driver and, through image processing, detect a smart phone in the driver's hand.

In some embodiments, the image processing can be used to detect the face and/or eyes of the driver to determine the direction of gaze of the driver's eyes, e.g., towards the mobile device rather than on the road. In some embodiments, the sensors can capture data regarding the motion or trajectory of the surrounding vehicles, and determines if unexpected trajectories (e.g., swerving, sudden or erratic acceleration/deceleration, or the like) are occurring which is indicative of an incapacitated driver. In some embodiments, the system can rely primarily on camera-based images/video capture for detecting the incapacitated driver. In some embodiments, the system can rely on data from additional sensors, e.g., LiDAR, radar, or the like, with the data being fused with camera-based data to enhance the detection process. For example, the sensor data can be converted to a fused object list, e.g., including perception of the environment.

If an incapacitated driver is detected, the primary vehicle is automatically actuated to operate in a safe operation mode to avoid a potential collision with the vehicle of the incapacitated driver. As non-limiting examples, the safe operation mode can include, e.g., increasing a longitudinal and/or lateral distance relative to the vehicle of the incapacitated driver, avoiding lane changes closer to the vehicle of incapacitated driver, initiating lane changes to create a greater distance from the vehicle of the incapacitated driver, applying a heavier weight to unlikely trajectories estimated for the vehicle of the incapacitated driver based on an expectation of a safety critical maneuver from the vehicle, combinations thereof, or the like.

The safe operation mode therefore ensures that the primary vehicle takes greater care in moving along the route while the incapacitated driver is located in the surrounding vehicle, and may generate additional lane changes for the vehicle to create a larger distance between the primary vehicle and the vehicle of the incapacitated driver. In some embodiments, the system can issue an alert to the primary vehicle via, e.g., a graphical user interface, to notify a driver regarding the incapacitated river in a surrounding vehicle. In some embodiments, the system can issue an alert to mission control and/or local authorities regarding an incapacitated driver, including information regarding the vehicle, e.g., make, model, year, license plate, or the like.

The primary vehicle is therefore equipped with multiple sensors, e.g., cameras, LiDAR, radar, combinations thereof, or the like. The sensors are positioned in places on the vehicle that provide angles and heights for detection of drivers in surrounding vehicles. For example, in some embodiments, the sensors can be disposed on the side mirrors with a field-of-view at a horizontal or downwardly facing angle which allows for detection of a driver within a vehicle, as well as objects or items that may be distracting the driver. The sensor data can be fused to generate an object list that includes detected driver and object information. For example, a processing device of the system can analyze the sensor data (e.g., through image recognition) to detect and output that the driver is on their mobile device. The sensor data can also be used to perceive the surrounding environment, allowing the vehicle operation to be regulated based on the incapacitated driver detection, e.g., to react the vehicle operation if the incapacitated driver performs a risky or emergency maneuver.

As the primary vehicle moves through an environment, e.g., along a road, the sensors can observe and detect objects in the environment. The sensors can be used to detect and track surrounding vehicles, and generate expected or estimated trajectories for these vehicles. One or more cameras can be used to detect if the driver of a surrounding vehicle is on their mobile device, for example. Machine learning and/or artificial intelligence can be used for execution of an image recognition algorithm to analyze the images captured by the sensors to detect driver and vehicle characteristics. The data can be analyzed in real-time to automatically adjust operation of the primary vehicle accordingly. In some embodiments, the sensor data can be processed at a processing device at the primary vehicle to adjust operation of the primary vehicle. In some embodiments, the sensor data can be transmitted to an external processing device, e.g., at mission control, and instructions can be transmitted to the primary vehicle from the external source to adjust operation of the primary vehicle.

If a driver is flagged/marked as being incapacitated by the system, the primary vehicle operation can be adjusted to create a safety zone or buffer relative to the incapacitated driver vehicle. For example, while the safety zone is always in existence around the primary vehicle to avoid collisions with surrounding vehicles and objects, this safety zone can be increased in size (e.g., laterally and/or longitudinally) to create a greater safety buffer relative to the incapacitated driver vehicle. The increased safety buffer ensures that the primary vehicle will have sufficient time to react to a potentially emergency maneuver or situation associated with the incapacitated driver vehicle. It should be understood that the increase in the safety zone can vary depending on the type of distraction/incapacitation of the driver, as well as the operating characteristics of the secondary vehicle.

For example, if the vehicle of the incapacitated driver is accelerating at a rate significantly higher than expected or relative to other vehicles in the environment, the safety zone can be increased by a greater amount than if the acceleration rate is only minimally greater than other surrounding vehicles. Another example of increasing a safety zone involves the vehicle selecting another preferred lane and performing a lane change to increase the distance (lateral and/or longitudinal) to the other roadway user/vehicle. Another example of increasing a safety zone involves proactively reducing the vehicle speed, especially for larger vehicles (e.g., semi-truck) which necessitate longer stopping distances, to allow for a greater stopping distance overall. Another example of increasing a safety zone involves, in extreme cases, driving the vehicle over the dividing line or onto the shoulder itself (e.g., if the lateral distance with the other vehicle is decreased significantly and there are no other options). As a non-limiting example, if the traditional 3 second rule is used for typical highway operation for purposes of maintaining a safe distance from surrounding vehicles, during encounters with incapacitated drivers, the vehicle can be actuated to operate under an increased time, e.g., 3.5 or 4 second rule, or the like, thereby providing additional reaction time to the vehicle.

Using the sensor data, the system can monitor and estimate the expected trajectory of the secondary vehicle. For example, if the secondary vehicle is swerving within its lane, the continued swerving action can be used to estimate that the swerving will continue adjacent to the primary vehicle. In such a case, the primary vehicle can be operated to provide a greater lateral buffer relative to the secondary vehicle, or can be actuated to change lanes completely to create a full lane buffer relative to the swerving vehicle. The swerving data and expected trajectory can also be used to determine if the swerving vehicle will be moving away or towards the primary vehicle based on its acceleration within the lane. If the vehicle is expected to swerve towards the primary vehicle, distancing action can be taken. If the vehicle is expected to swerve away from the primary vehicle, a minimal distancing action or no action can be taken, with continued monitoring of the actual trajectory of the vehicle.

In some embodiments, the incapacitated driver can be flagged and related data can be transmitted to local authorities to report the incapacitate driver. For example, license plate and video/image data can be transmitted to local authorities such that the driver can be stopped by local police. In some embodiments, if a fleet of vehicles are operating in tandem, the flagged incapacitated driver information can be transmitted to fleet vehicles in the vicinity (e.g., a predetermined radius or along the same route) to put these fleet vehicles on notice of the incapacitated driver. The fleet vehicles can, in turn, adjust their operation into a safety mode as they approach the incapacitated driver (or the driver approaches them). The system therefore increases the safe operation of the primary vehicle based on detection of incapacitated drivers in the surrounding vehicles.

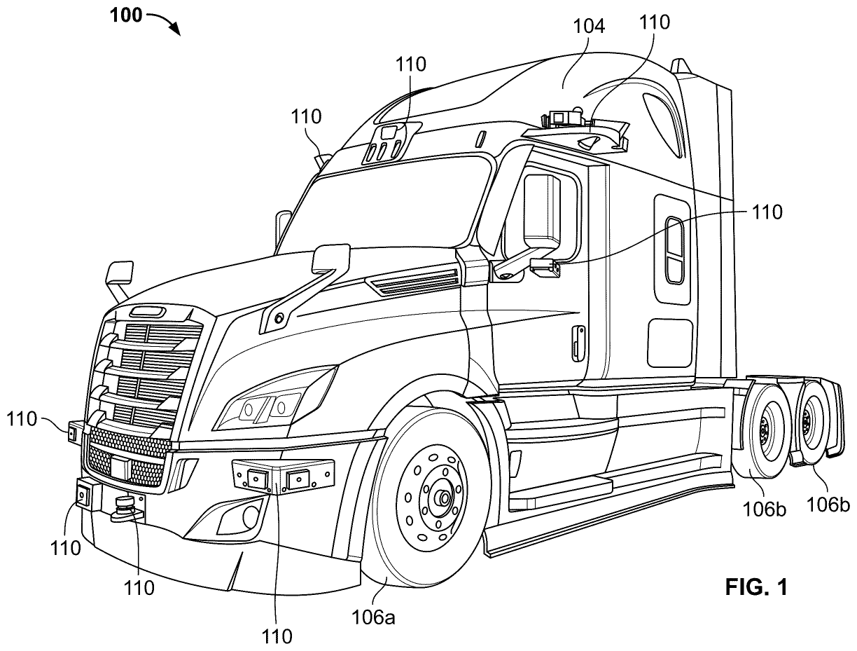

Various embodiments in the present disclosure are described with reference to FIGS. 1-13 below.

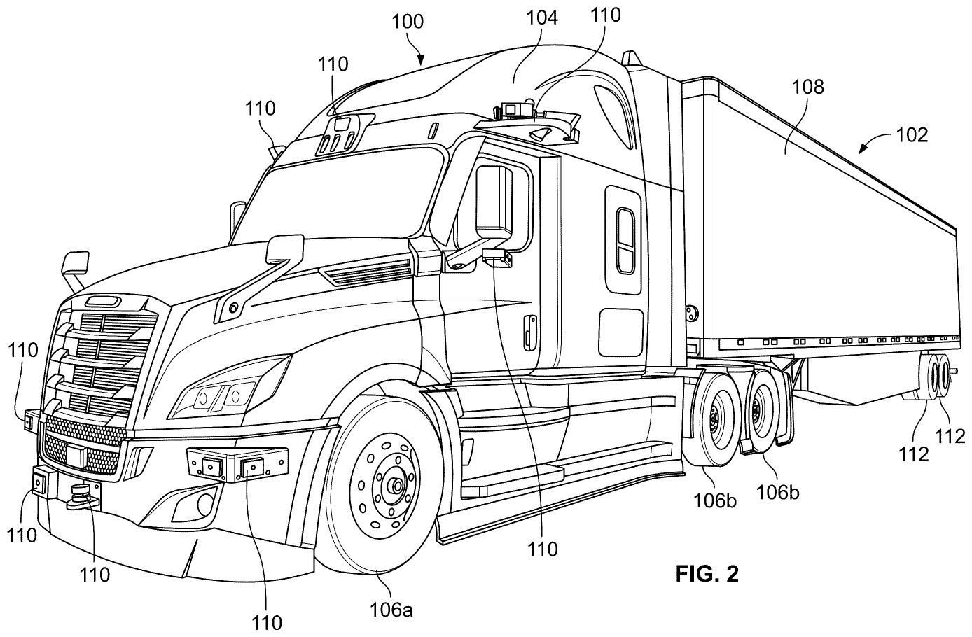

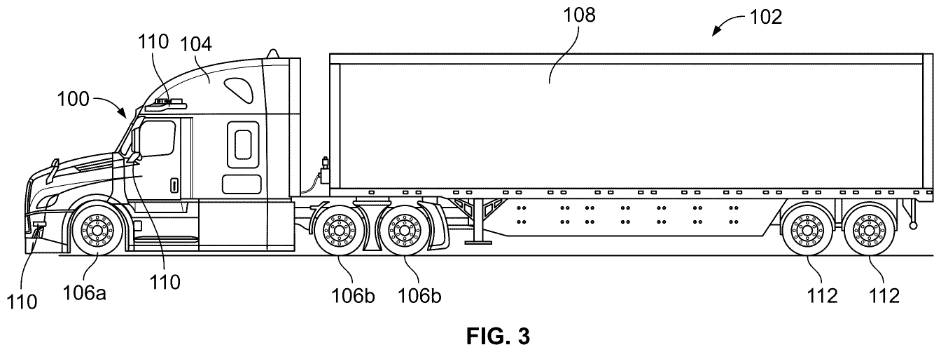

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

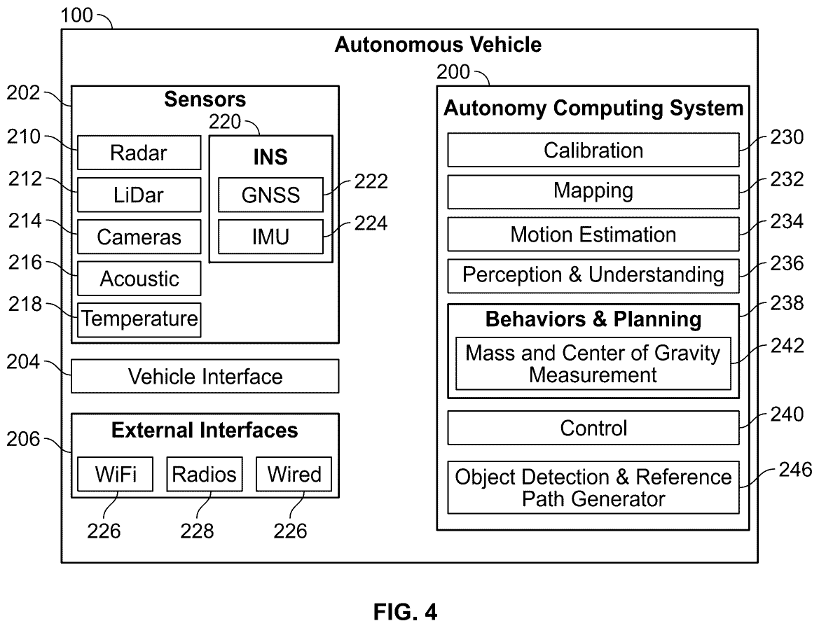

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, cither autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

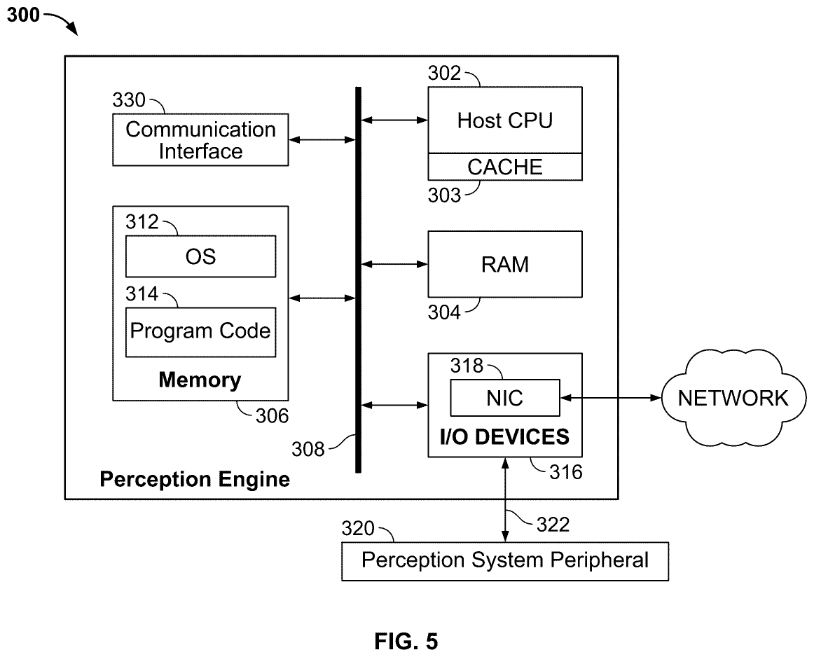

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

FIG. 6 is a block diagram of an exemplary system 400 for incapacitated driver detection. The system 400 generally includes one or more vehicles 402 (e.g., autonomous vehicle 100). Each vehicle 402 includes a processing device 404 (e.g., computing system 200, computing system 300, or the like) configured to receive and process data for detecting incapacitated drivers around the vehicle 402. The processing device 404 can also generally detect secondary vehicles 406 in the environment around the vehicle 402, and determines the actual and estimated trajectory of the secondary vehicles 406 to determine if action needs to be taken by the vehicle 402 to avoid a collision with the secondary vehicles 406. At least some of the data received by the processing device 404 can be data from one or more sensors 408 (e.g., sensors 202).

The sensors 408 can have field-of-views directed outward and away from the vehicle 402, particularly oriented to detect driver and vehicle characteristics associated with the secondary vehicles 406. The vehicle 402 includes various operational systems 410 (e.g., computing system 200) for regulating the planned and current movement of the vehicle 402 through the environment. The vehicle 402 can, in some embodiments, include a user interface 412, e.g., a graphical user interface, configured to receive input of information and output information regarding operation of the vehicle 420 and/or the system 400. For example, one or more alerts 414 can be displayed at the user interface 412, as discussed herein.

The vehicle 402 can include one or more databases 416 (e.g., memory 306) configured to receive and electronically store data. In some embodiments, the database 416 can be stored externally from the vehicle 402 and the vehicle 402 can be in communication with the external database 416 for receiving and/or transmitting data associated with the system 400. For example, the database 416 can be located at an external source, e.g., mission control 418, with which the vehicle 402 is in communication. In some embodiments, the data from the sensors 408 relating to the system 400 can be at least partially analyzed at the vehicle 402, at mission control 418, or both, to determine if adjustment to operation of the vehicle 402 is necessary based on an incapacitated driver of a secondary vehicle 406.

As the vehicle 402 moves through the environment, the sensors 408 gather sensor data 420 regarding the secondary vehicles 406. This data 420 can be used to operate the vehicle 406 in a manner that avoids collisions with the vehicles 406, as well as other objects in the environment. The sensor data 420 can include images and/or video feed from cameras that capture drivers within the secondary vehicles 406. The sensor data 420 can be analyzed via, e.g., an image detection algorithm, or the like, to detect if the driver of the vehicle 406 is incapacitated. This information can be labeled as driver characteristics 422 and can include detection of, e.g., a mobile device in the driver's hand, food being consumed by the driver, the driver turned around in the seat, closed eyes of the driver indicating sleeping, an alcoholic beverage in the vehicle 406, or the like. In some embodiments, the driver characteristics 422 on their own can be used to label the vehicle 406 as having an incapacitated driver designation 424.

In some embodiments, the system 400 can necessitate fusion of the driver characteristics 422 with secondary vehicle characteristics 426 (and/or secondary vehicle trajectory 428) before labeling the vehicle 406 as having the incapacitate driver designation 424. In some embodiments, one or more of the driver characteristics 422, the secondary vehicle characteristics 426, and/or the secondary vehicle trajectory 428, can be used to label the vehicle 406 as having an incapacitated driver designation 424. In some embodiments, only one of these items of information can be used by the system 400 to label the vehicle 406 as an incapacitated driver. In some embodiments, two or more of these items of information can be used in combination to increase the confidence score/value for determining and labeling the vehicle 406 as having an incapacitated driver. In particular, the sensor data 420 can be used to monitor the current actions/motion taken by the vehicles 406. The sensor data 420 can include data from LiDAR, radar, combinations thereof, or the like. The sensor data 420 can include, e.g., the current acceleration/deceleration of the vehicle 406, the current trajectory of the vehicle 406, the current swerving pattern or action of the vehicle 406, the longitudinal and/or lateral distance of the vehicle 406 relative to the vehicle 402, or the like.

Using this data 420, the system 400 can determine if the current actions/motion of the vehicle 406 are indicative of an incapacitated driver. For example, the acceleration/deceleration of the vehicle 406 is uneven or at a higher rate than other surrounding vehicles, this can be indicative of an incapacitated driver. In some embodiments, a z-score can be used to measure how many standard deviations a data point is from the mean of the dataset (e.g., how far from the mean), and this information can be applied to vehicles 406 and their acceleration/deceleration detected by the sensors. In some embodiments, the system 400 can define a percentile range, such as the value below which a given percentage of observations fall (e.g., the 25th percentile would be the value below which 25% of the data lies). In some embodiments, the lowest/highest 10% percentile could be considered extreme and abnormal for acceleration/deceleration. As a further example, swerving of the vehicle 406 over lane markers can be indicative of an incapacitated driver. The current actions/motion of the vehicle 406 (stored as the secondary vehicle characteristics 426) can indicate unsafe operation of the vehicle 406, which can influence operation of the vehicle 406. In some embodiments, the secondary vehicle characteristics 426 can be used to generate an estimated secondary vehicle trajectory 428.

In some embodiments, if the vehicle 406 was operating within average acceleration/deceleration rates (relative to other vehicles), indicating “normal” operation (e.g., smooth or stable operation), the trajectory 428 can be estimated to continue in this manner. In such normal, smooth or stable operation, the system 400 estimates that the driver would operate the vehicle in the expected manner (e.g., driving straight within the lane, making smooth continuous turn in curving road, uniform acceleration or deceleration, or the like) and does not perform any unplanned or sudden maneuvers (e.g., swerving left to right, driving over lane lines, sudden acceleration or deceleration, or the like). If, however, the sensor data 408 subsequently shows that the vehicle 406 is operating outside of the expected “normal” trajectory 428, this difference can be used to label the vehicle 406 as having an incapacitated driver designation 424. In some embodiments, the system 400 can rely on mathematical expressions with statistical data, e.g., measurements regarding acceleration and velocity, lane position, or the like, with any data of these characteristics in the 10^{th} percentile being considered abnormal. In some embodiments, a high z-score (far away from the distribution) can be considered an outlier and representative of abnormal driving. Thus, fluctuations of the vehicle 406 from a “normal” operation can be used as a guide for detecting an incapacitated driver.

In some embodiments, if the vehicle 406 was operating with unsafe or abnormal motion, e.g., swerving, uneven acceleration/deceleration, high rates of acceleration/deceleration, or the like, the trajectory 428 can indicate that the expected motion of the vehicle 406 will continue in this manner. This estimated trajectory 428 can be used to plan the potential motion/action of the vehicle 402 to avoid a collision with the vehicle 406 should the trajectory 428 coincide with the vehicle 402. For example, if the vehicle 406 is continuously swerving in a lane, the trajectory 428 can estimate whether the vehicle 406 will be swerving towards or away from the vehicle 402 as the vehicle 406 approaches the vehicle 402. This estimated trajectory 428 can be used to determine if the vehicle 402 should provide greater lateral distance relative to the vehicle 406, e.g., by switching lanes or shifting within its lane.

In some embodiments, the data gathered from the sensors 408 can be weighed to generate a confidence score or value for the incapacitated driver designation 424 label. For example, the higher the number of images captured and indicating that the driver is distracted/incapacitated, the higher the confidence score/value. Similarly, if a high number of images are captured within a predetermined timeframe, e.g., several seconds, with the driver shown as being incapacitated, the confidence score/value for the designation 424 can be increased (e.g., based on confirmation from the multiple sequential images showing the incapacitated driver). In some embodiments, the confidence score/value for the designation 424 can be equal to or above a predetermined threshold value in order for the vehicle operation to be adjusted to the safe operation mode.

In some embodiments, the confidence value for detection of an incapacitated driver can be higher when the secondary vehicle is closed to the primary vehicle as compared to further away, e.g., due to higher clarity in the image, improved angle/visualization of the driver within the secondary vehicle, or the like. For example, the confidence value for the determination can be higher if the secondary vehicle is 10 ft away from the primary vehicle when the image is captured of the driver, as compared to when the secondary vehicle is 30 ft away from the primary vehicle when the image is captured. In some embodiments, the confidence score can be higher for detection of certain larger items distracting the driver as compared to smaller items (e.g., detection/visualization of a large mobile device would have a higher confidence score). In some embodiments, the confidence score can be a value between 0 to 1, inclusive, with, e.g., 0.5 and greater indicative of an incapacitated driver and below 0.5 indicative of a normal driver.

If a vehicle 406 around the vehicle 402 has received an incapacitated driver designation 424, the processing device 404 can adjust one or more of the operational systems 410 to operate under a safety operation mode 430. In some embodiments, the safety operation mode 430 can only be used if the vehicle 406 with the incapacitated driver designation 424 is within a predetermined distance of the vehicle 402. In some embodiments, the range of the sensors 408 can determine when the safety operation mode 430 is initiated, so long as an incapacitated driver is detected within the range of the sensors 408. For example, if the range of the sensors 408 is about 150 m around the vehicle 402, detection and labeling of an incapacitated driver anywhere in this radius can be used to initiate the safety operation mode 430. In some embodiments, the vehicle 406 of the incapacitated driver must be within a predetermined distance, or traveling towards the vehicle 402, before the safety operation mode 430 can be initiated. For example, if the vehicle 406 is on the outskirts of the sensor 408 field-of-view range and traveling away from the vehicle 402, the safety operation mode 430 can be avoided due to departure of the vehicle 406. However, if the vehicle 406 returns to the field-of-view range of the sensors 408, the safety operation mode 430 can be initiated.

In particular, the vehicle 402 generally includes a planned route 432, e.g., a mission route. The planned route 432 can include a variety of actions to be performed by the vehicle 402, e.g., straight motion, curving motion, turns, deceleration, acceleration, longitudinal/lateral distances to be maintained relative to surrounding vehicles 406, combinations thereof, or the like. If the safety operation mode 430 is initiated, one or more of these actions can be adjusted to provide additional safety to the vehicle 402, e.g., an increased safety zone or buffer. For example, the vehicle 402 can be actuated to accelerate or decelerate (depending on the location of the vehicle 406) to increase the longitudinal distance between the vehicles 402, 406. As a further example, the vehicle 402 can be actuated to shift in its lane or change lanes to create a greater lateral distance between the vehicles 402, 406. As a further example, the vehicle 402 can avoid a planned lane change or turn in order to avoid a collision with the vehicle 406.

In some cases (e.g., extreme cases), the vehicle 402 can perform a minimal risk maneuver by departing the primary road and driving on the shoulder, or leaving the road completely to avoid a collision with the vehicle 406. In some embodiments, the vehicle 402 can use a horn, warning lights, hazard lights, combinations thereof, or the like, to alert the driver of the vehicle 406 if incapacitation of the driver is detected. In each of these instances, the action taken by the vehicle 402 is intended to create additional time for reacting to an abrupt change in motion of the vehicle 406, thereby avoiding a collision. The safe operation mode 430 is therefore initiated based on actions of vehicles 406 in the surrounding environment, and assists with safe passage of the vehicle 402 through the environment.

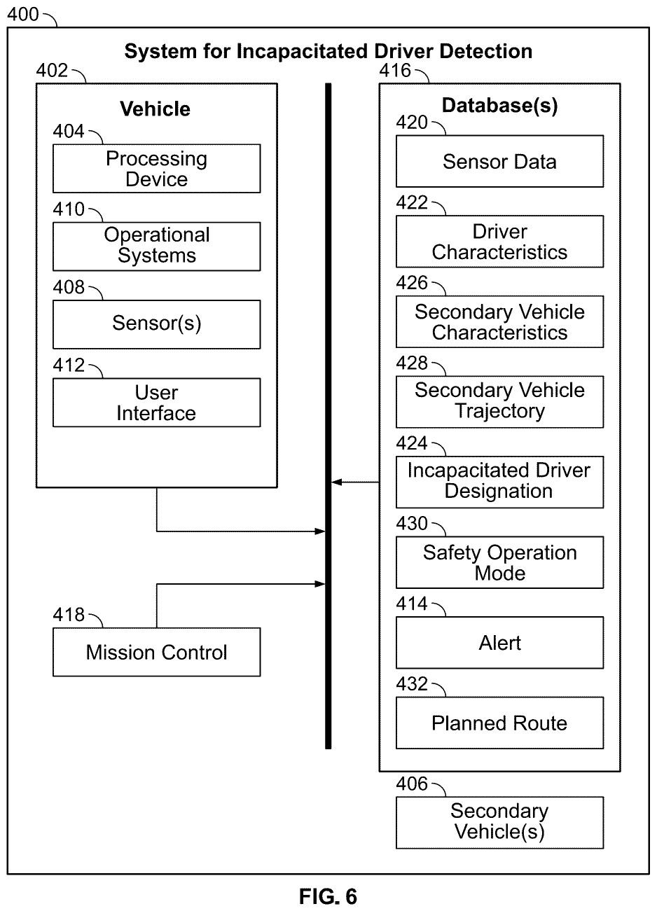

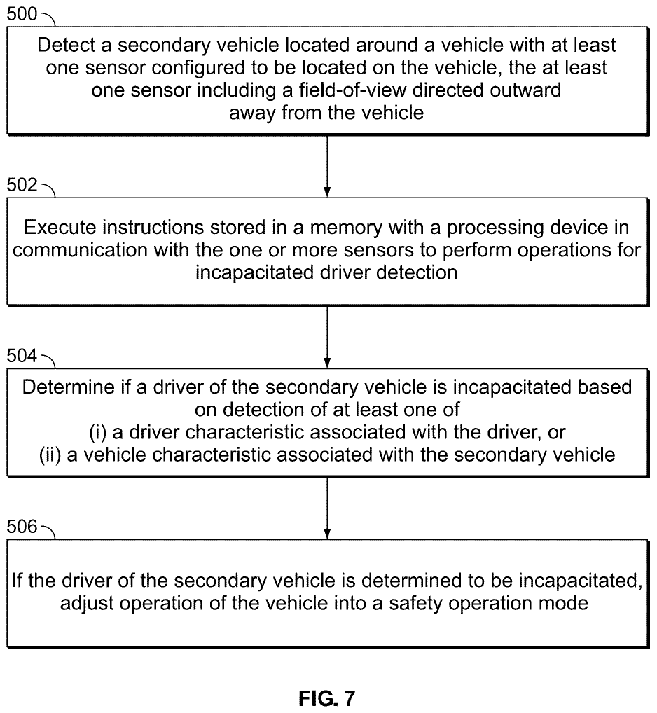

FIG. 7 is a flowchart of a method of incapacitated driver detection by the exemplary system 400 discussed herein. At 500, a secondary vehicle located around a primary vehicle is detected with at least one sensor configured to be located on the primary vehicle. The sensor includes a field-of-view directed outward away from the primary vehicle. At 502, instructions stored in a memory are executed with a processing device in communication with the sensor to perform operations for incapacitated driver detection.

At 504, a determination is made whether the driver of the secondary vehicle is incapacitated. This determination can be made on detection of a driver characteristic associated with the driver (e.g., a mobile phone in the driver's hand, food being consumed by the driver, closed eyes indicating a sleeping driver, or the like), a vehicle characteristic associated with the secondary vehicle (e.g., swerving, uneven acceleration/deceleration, a high rate of acceleration/deceleration compared to surrounding vehicles, or the like), or a combination of both. At 506, if the driver of the secondary vehicle is determined to be incapacitated, operation of the primary vehicle is adjusted into a safety operation mode to increase a safety buffer around the primary vehicle, thereby preventing a collision with the secondary vehicle.

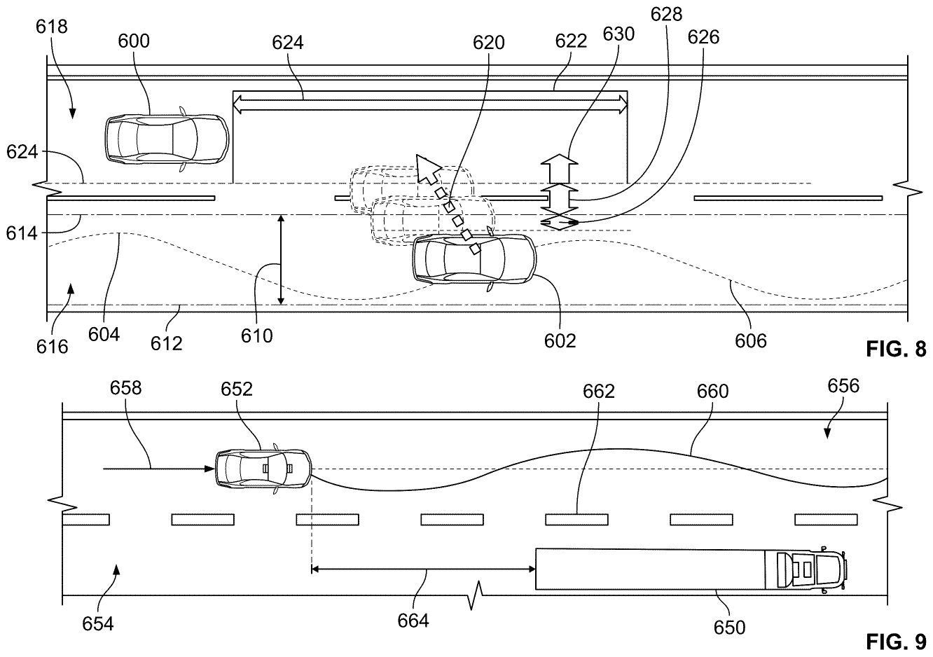

FIG. 8 is a diagrammatic view of an environment in which the exemplary system 400 can be used. The vehicle 600 can be the primary vehicle with the system 400, and the vehicle 602 can be the secondary vehicle 602 with the incapacitated driver. Sensors of the vehicle 600 can be oriented to capture images through the windows of the vehicle 602 to determine if the driver of the vehicle 602 is incapacitated. The sensors of the vehicle 600 can also be used to detect the current or past trajectory 604 of the vehicle 602 to generate an estimated trajectory 606. For example, the vehicle 602 is shown to have a swerving trajectory 604, and the system can estimate that the expected or estimated trajectory 606 will also be swerving. The amplitude of the swerving trajectory 604, 606 can be labeled as a distance 608 of a wandering zone 610 with right and left limits 612, 614 of travel for the vehicle 602. The wandering zone 610 may be within the lane 616 of the vehicle 602, or can pass into surrounding lanes, such as the lane 618 of the vehicle 600.

The sensors of the vehicle 600 can capture acceleration and/or deceleration data for the vehicle 602 and, based on this data, can estimate the potential for the vehicle 602 to change lanes 616, 618 in the direction 620, as well as the rate at which the vehicle 602 could move to make the lane 616, 618 change. The system can generate a safety zone 622 in front of the vehicle 600 (as well as around the vehicle 600 in general) to indicate the minimum braking area in case an emergency occurs. For example, the safety zone 622 can define a minimal braking distance 624 in front of the vehicle 600. As illustrated in FIG. 8, if the vehicle 602 moves along direction 620 into the safety zone 622, the vehicle 600 will not have sufficient time and distance to brake effectively should an emergency occur.

Similarly, lateral movement of the vehicle 600 towards the lane 618 can result in crossing of the vehicle 602 over a plane 624 defining a side edge of the safety zone 622. This lateral movement can include an initial distance or zone 626 in which minimal movement maintains a safe distance between the vehicles 600, 602; an intermediate distance or zone 628 with a minimal perception time for the vehicle 600 to adjust operation; and an alert distance or zone 630 in which a braking delay would occur because the vehicle 602 is within the safety zone 622. In some embodiments, during normal operation of the vehicle 602, any motion of the vehicle 602 beyond the zone 626 can be indicative of a lane change, which would necessitate action by the vehicle 600. However, for distracted drivers, if fluctuations or swerving of the vehicle 602 are detected, the normal operation expectations can be given less weight and the vehicle 600 can expect a higher chance of lane changes even if the vehicle 602 is within the zone 626. In some embodiments, the zone 626 can be about 0.37 m, the zone 628 can be about 0.72 m, and the zone 730 can be about 0.75 m.

Based on the trajectories 604, 606 of the vehicle 602 (and/or images of the incapacitated driver), the system can determine whether the vehicle 602 should be labeled as having an incapacitated driver. If such label is assigned, the system can adjust the vehicle 600 operation to be in a safety mode which increases the safety zone 622 laterally and/or longitudinally to provide more clearance between the vehicles 600, 602. The safety mode for the vehicle 600 can also be used to increase the overall lateral and longitudinal distance between the vehicles 600, 602 to avoid a potential collision.

FIG. 9 similarly illustrates an environment in which a primary vehicle 650 and a secondary vehicle 652 travel within their respective lanes 654, 656. However, the previous or current trajectory 658 of the vehicle 652 is initially linear, while the expected or estimated trajectory 660 is indicative of swerving due to an incapacitated driver. The estimated trajectory 660 can be generated by the system based on images of the driver in an incapacitated state, with the system using machine learning or artificial intelligence processing to estimate what type of motion the vehicle 652 can make when the driver is in the detected incapacitated state.

The type of motion/trajectory estimated may be dependent on the type of incapacitation detected. For example, sleeping may have a different result on the vehicle 652 motion as compared to eating food while driving, and historical data can be used to generate the estimated trajectory 660 in this manner. \For example, sleeping may indicate a trajectory 660 that would cross the dividing lane lines 662, while eating food while driving may result in swerving within the lane 656. However, once the incapacitated driver label is made for the vehicle 652, the vehicle 650 can be operated in the safety mode to, e.g., adjust the longitudinal distance 664 between the vehicles 650, 652. Additional adjustments can be made by the vehicle 650, as discussed herein, to ensure safe distances and operation relative to vehicle 652.

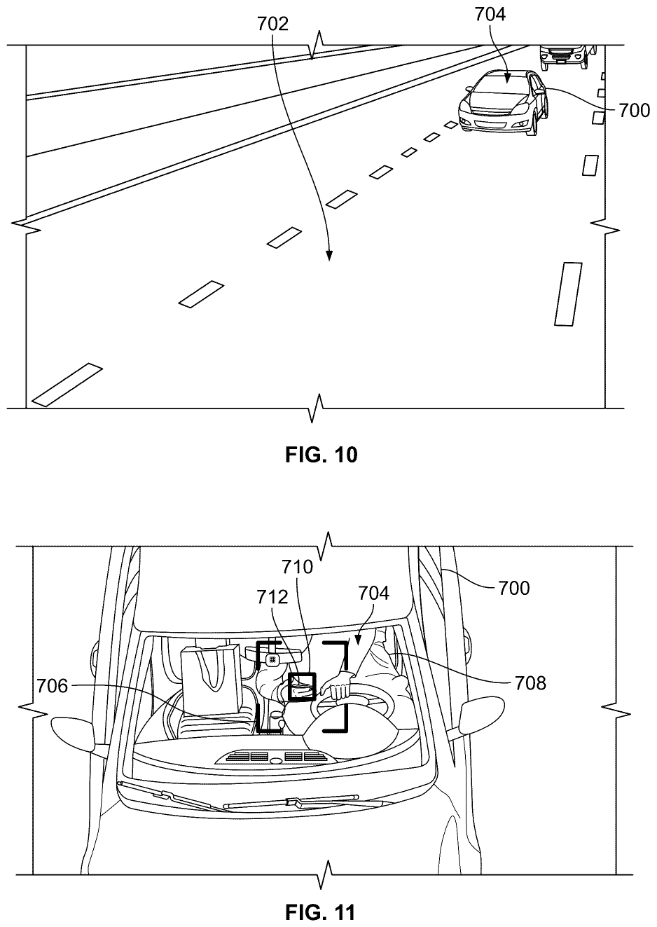

FIGS. 10 and 11 are example images captured by a sensor of the primary vehicle to detect an incapacitated driver within a vehicle. For example, FIG. 10 shows a vehicle 700 detected in the environment around the primary vehicle and traveling in a lane 702 (e.g., the same lane or an adjacent lane). The angle of the field-of-view of the sensor allows for a direct view through the side windows or windshield of the vehicle 700 and into the interior 704 of the vehicle 700.

FIG. 11 provides a close-up image of the vehicle 700 from FIG. 10, including a more detailed view of the interior 704 of the vehicle 700. In some embodiments, image processing by the system can involve generation of a bounding box 706 corresponding with, e.g., the driver 708, a hand or arm of the driver 708, or the like. The system can further generate a more specific bounding box 710 within the bounding box 706 corresponding with a detected object 712, e.g., a mobile device, in the driver's hand. Image recognition can be used to identify the type of object to determine if the driver 708 is incapacitated. In some embodiments, the driver's face can be detected, including detection of the eyes and the direction of the driver's gaze (or if the eyes are closed), to determine if the driver is incapacitated. The driver 708 in FIG. 11 would be labeled as incapacitated, allowing the primary vehicle to adjust operation into the safety mode to avoid a potential collision with the vehicle 700.

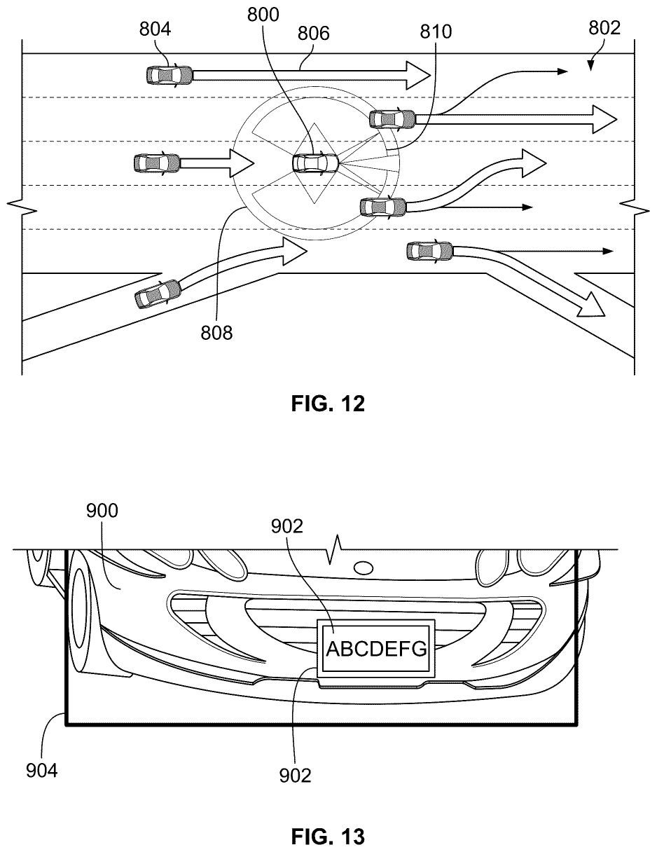

FIG. 12 is a diagrammatic view of a primary vehicle 800 in an environment including multiple lanes 802 with secondary vehicles 804. Each of the secondary vehicles 804 can include a trajectory 806, whether actual or estimated by the system. As discussed herein, the vehicle 800 includes sensors configured to detect characteristics of the driver of the vehicles 804 and/or the vehicles 804 themselves to determine if the driver is incapacitated. Based on the sensor data, the vehicle 800 can operate with a safety zone 808 around the vehicle 800.

A section 810 of the safety zone 808 at the front of the vehicle 800 can be specifically generated to provide the vehicle 800 with sufficient time to decelerate or change course, if needed, when a secondary vehicle 804 moves in front of the vehicle 800. Based on detection of an incapacitated driver in one or more of the vehicles 804, the system can adjust operation of the vehicle 800 into a safety mode, thereby also adjusting the safety zone 808 and section 810 to ensure safe passage of the vehicle 800 through the environment.

In some embodiments, the system can report the incapacitated driver to local authorities. In some embodiments, the system can report the incapacitated driver to local authorities only if the driving laws are broken, e.g., going over a speed limit by a predetermined amount, going below a speed limit by a predetermined amount, not stopping at a stop sign, illegal crossing of lane lines, or the like. In some embodiments, the system can report the vehicle if the vehicle is involved in an accident, e.g., with the primary vehicle, another vehicle, or a static object. In such embodiments, the system can use the captured image from the sensor(s) for the vehicle 900 to locate and identify a license plate 902 with the corresponding number. For example, the system can generate a first bounding box 904 for the front of the vehicle 900, and a second bounding box 906 within the bounding box 904 for the license plate 902. This information, along with the make and model of the vehicle 902 (optionally) can be transmitted to local authorities to reduce the risk of a collision occurring with the vehicle 900.

In some embodiments, if a fleet of vehicles operates concurrently in the environment, the information relating to the vehicle 900 labeled as having an incapacitated driver can be transmitted to fleet vehicles in the vicinity of the vehicle 900 to warn drivers and/or vehicles of the incapacitated nature of the driver. The system therefore optimizes the safe passage of vehicles through an environment based on detection of incapacitated drivers around the primary vehicle and adjusting operation of the primary vehicle accordingly.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for incapacitated driver detection, comprising:
at least one sensor configured to be located on a vehicle, the at least one sensor including a field-of-view directed outward away from the vehicle; and
a processing device in communication with the at least one sensor, wherein the processing device is configured to execute instructions stored in a memory to perform operations comprising:
detecting a secondary vehicle located proximate the vehicle;
determining if a driver of the secondary vehicle is incapacitated based on detection of at least one of (i) a driver characteristic associated with the driver, or (ii) a vehicle characteristic associated with the secondary vehicle; and
if the driver of the secondary vehicle is determined to be incapacitated, adjusting operation of the vehicle into a safety operation mode.

2. The system of claim 1, wherein the at least one sensor is configured to detect the driver within the secondary vehicle and determine the driver characteristic.

3. The system of claim 2, wherein the operations comprise using machine learning and/or image recognition to determine the driver characteristic.

4. The system of claim 2, wherein the driver characteristic includes a mobile device distracting the driver.

5. The system of claim 2, wherein the driver characteristic includes the driver sleeping, eating, or checking a radio within the secondary vehicle.

6. The system of claim 1, wherein the at least one sensor is configured to detect an unexpected trajectory of the secondary vehicle as the vehicle characteristic.

7. The system of claim 6, wherein the unexpected trajectory includes swerving of the secondary vehicle.

8. The system of claim 6, wherein the unexpected trajectory includes higher acceleration of the secondary vehicle relative to surrounding vehicles.

9. The system of claim 6, wherein the unexpected trajectory includes uneven acceleration or deceleration of the secondary vehicle.

10. The system of claim 1, wherein the safety operation mode includes increasing a longitudinal and/or lateral distance of the vehicle relative to the secondary vehicle.

11. The system of claim 1, wherein the safety operation mode includes guiding the vehicle to a lane further from the secondary vehicle.

12. The system of claim 1, wherein the safety operation mode includes avoiding a planned lane change which would bring the vehicle closer to the secondary vehicle.

13. The system of claim 1, wherein the safety operation mode includes accelerating or decelerating the vehicle to increase a distance between the vehicle and the secondary vehicle.

14. The system of claim 1, wherein the operations comprise issuing an alert to surrounding vehicles regarding the incapacitated driver and the secondary vehicle.

15. The system of claim 1, wherein the vehicle is an autonomous or a semi-autonomous vehicle.

16. The system of claim 1, wherein the at least one sensor is a camera.

17. The system of claim 1, wherein the at least one sensor is radar, LIDAR, or both.

18. A computer-implemented method for incapacitated driver detection, comprising:
detecting a secondary vehicle located proximate a vehicle with at least one sensor configured to be located on the vehicle, the at least one sensor including a field-of-view directed outward away from the vehicle; and
executing instructions stored in a memory with a processing device in communication with the at least one sensor to perform operations comprising:
determining if a driver of the secondary vehicle is incapacitated based on detection of at least one of (i) a driver characteristic associated with the driver, or (ii) a vehicle characteristic associated with the secondary vehicle; and
if the driver of the secondary vehicle is determined to be incapacitated, adjusting operation of the vehicle into a safety operation mode.

19. The method of claim 18, wherein the operations comprise detecting the driver within the secondary vehicle and determining if the driver is distracted by a mobile device.

20. The method of claim 18, wherein the operations comprise detecting with the at least one sensor an unexpected trajectory of the secondary vehicle as the vehicle characteristic.
